(19) United States
(12) Patent Application Publication
(10) Pub. No.: US 2019/0307210 A1
(43) Pub. Date: Oct. 10, 2019

(54) MANUFACTURING METHOD OF VAMP WITH EMBOSSED PATTERN AND MANUFACTURING SYSTEM THEREOF

(71) Applicant: LONG JOHN TSUNG RIGHT INDUSTRIAL CO., LTD., Pei-Tou Chang-Hwa (TW)

(72) Inventors: Wen-Tsao WEN, She-Tou Township (TW); Yu-Chang WEN, Puxin Township (TW)

(21) Appl. No.: 16/448,982

(22) Filed: Jun. 21, 2019

Related U.S. Application Data
(63) Continuation-in-part of application No. 15/368,996, filed on Dec. 5, 2016.

(30) Foreign Application Priority Data
Dec. 22, 2015 (TW) 104220547

(51) Int. Cl. A43D 8/22; B29D 35/12; A43B 23/02; A43B 3/00

(52) U.S. Cl. CPC A43D 8/22; B29D 35/126; B29K 2105/256; A43B 23/0255; A43B 3/0078; A43B 23/0235

(57) ABSTRACT

The present disclosure illustrates a manufacturing method of a vamp with an embossed pattern comprising: (1) providing a plain cloth. (2) heating the plain cloth by an oven to soften the plain cloth. (3) cooling the plain cloth and forming an embossed pattern on the plain cloth by a cold pressing roller, and the cold pressing roller provided with a predetermined pattern. (4) forming an embossed layer with the embossed pattern on the plain cloth. Because of the cold pressing roller, a depth of the cooled embossed layer is the same as a depth of the predetermined pattern. Hence, the embossed pattern can maintain its appearance.

### CROSS-REFERENCE TO RELATED APPLICATION

This application claims the benefit of Taiwan Patent Application No. 104220547, filed Dec. 22, 2015 at the Taiwan Intellectual Property Office. This application is a continuous-in-part of U.S. patent application Ser. No. 15/368,996 filed Dec. 5, 2016. The disclosures of both of the above applications are incorporated herein in their entirety by reference.

### BACKGROUND OF THE INVENTION

### 1. Field of the Invention

The present disclosure relates to a manufacturing method of a vamp with an embossed pattern and a manufacturing system thereof which utilizes the cooling and forming process by a cold pressing roller to maintain the depth of the embossed layer.

### 2. Description of the Related Art

While high technology industries such as the semiconductor industry have rapidly developed, the textile industry has so far generally remained traditional in its practices. The textile industry faces strong competition and pressure to continuously innovate and integrate new technologies in order to develop novel, high value-added products. In recent years, textile products have to perform well, be comfortable, include protection features and appear aesthetically appealing and fashionable. As a result functional fabrics have become a hot product in the textile industry.

A conventional embossed pattern is achieved by the thermal compression molding process. In detail, the plain cloth is placed in the mold and the thermal compression machine puts pressure and heat on the plain cloth. The surface of the plain cloth forms the embossed pattern. However, because of the material of the outer layer of the plain cloth, the depth of the embossed pattern is not same as the depth of the mold.

After much experience and study in the field, the inventor of the present disclosure has developed and designed a manufacturing method of a vamp with an embossed pattern and a manufacturing system thereof that overcomes the aforementioned problems to provide present-day desired features, while also improving on industrial practicability.

### SUMMARY OF THE INVENTION

An objective of the present disclosure is to provide a manufacturing method of a vamp with an embossed pattern and a manufacturing system thereof, to overcome the aforementioned limitations of conventional shoe build and design.

To achieve the objective, the present disclosure provides a manufacturing method of a vamp with an embossed pattern comprising: (1) providing a plain cloth. (2) heating the plain cloth by an oven to soften the plain cloth. (3) forming and cooling an embossed pattern on the plain cloth by a cold pressing roller at the same time, and the cold pressing roller provided with a predetermined pattern. (4) forming an embossed layer with the embossed pattern on the plain cloth. Wherein, the cooled embossed pattern is an inverse of the predetermined pattern and a depth of the cooled embossed layer is the same as a depth of the predetermined pattern. Because of the cold pressing roller, the embossed layer can maintain its appearance and be acted as a logo or a reinforcement structure.

Preferably, the manufacturing method of the vamp with the embossed pattern further comprises a step of forming a colored layer on the plain cloth by printing after providing the plain cloth.

Preferably, the plain cloth is provided with a crop mark, and the colored layer is in a range of a region defined by the crop mark.

Preferably, the manufacturing method of the vamp with the embossed pattern further comprises a step of forming a colored layer on the embossed layer by printing after forming the embossed layer.

Preferably, the plain cloth is a sandwiched fabric, and the sandwiched fabric is provided with a hot-melt adhesive yarn with dual melting points.

Preferably, a heating temperature for heating the plain cloth is in the range of 150° C. to 190° C.

Preferably, a cooling temperature for cooling the plain cloth is in the range of 15° C. to 30° C.

Preferably, the cold pressing roller is connected to a cooling water system.

To achieve the objective, a manufacturing system of a vamp with an embossed pattern comprises an oven and a cold pressing roller. The oven heats a plain cloth. The cold pressing roller is provided with a predetermined pattern. The cold pressing roller forms and cools an embossed pattern on the plain cloth at the same time, such that an embossed layer with the embossed pattern is formed on the plain cloth. Wherein, the embossed pattern is an inverse of the predetermined pattern, and a depth of the cooled embossed layer is the same as a depth of the predetermined pattern. Because of the cold pressing roller, the embossed layer can maintain its appearance and be acted as a logo or a reinforcement structure.

Preferably, the manufacturing system of the vamp with the embossed pattern further comprises a printing machine, and the printing machine prints a colored layer on the plain cloth.

Preferably, the printing machine prints a crop mark on the plain cloth and the colored layer is in the range of a region defined by the crop mark.

Preferably, the manufacturing system of the vamp with the embossed pattern further comprises a printing machine, and the printing machine prints a colored layer on the embossed layer.

Preferably, the plain cloth is a sandwiched fabric, and the sandwiched fabric is provided with a hot-melt adhesive yarn with dual melting points.

Preferably, the cold pressing roller is connected to a cooling water system.

According to the foregoing description, the manufacturing method of a vamp with an embossed pattern and the manufacturing system thereof are able to maintain the appearance of the embossed layer. The embossed layer may be acted as a logo or a reinforcement structure.

### BRIEF DESCRIPTION OF THE DRAWINGS

The detailed structure, operating principle and effects of the present disclosure will hereinafter be described in more detail with reference to the accompanying drawings that show various embodiments of the present disclosure.

FIG. 1 depicts a block diagram according to the manufacturing system of the vamp with the embossed pattern of the present invention.

FIG. 2 depicts a first structural diagram of the vamp with the embossed pattern in accordance with the present invention.

FIG. 3 depicts a second structural diagram of the vamp with the embossed pattern in accordance with the present invention.

FIG. 4 depicts a third structural diagram of the vamp with the embossed pattern in accordance with the present invention.

FIG. 5 depicts a flow chart of the first embodiment according to the manufacturing method of a vamp with an embossed pattern.

FIG. 6 depicts a flow chart of the second embodiment according to the manufacturing method of a vamp with an embossed pattern.

FIG. 7 depicts a structural diagram of the hot-melt yarn according to the manufacturing method of a vamp with an embossed pattern.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also intended to be included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present invention. As used herein, the term “or” includes any and all combinations of one or more of the associated listed items.

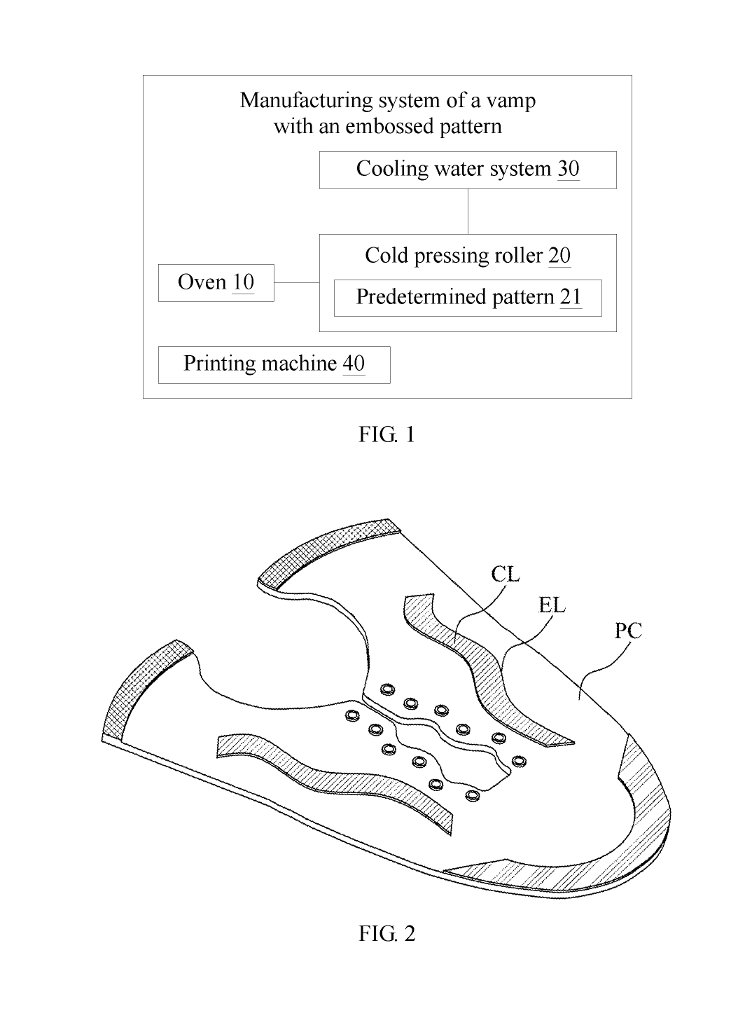

Refer to FIG. 1 to FIG. 4, which depicts a block diagram according to the manufacturing system of the vamp with the embossed pattern of the present invention, a first structural diagram of the vamp with the embossed pattern in accordance with the present invention, a second structural diagram of the vamp with the embossed pattern in accordance with the present invention and a third structural diagram of the vamp with the embossed pattern in accordance with the present invention. As illustrated by FIG. 1 to FIG. 4, the manufacturing system of the vamp with the embossed pattern comprises an oven 10, a cold pressing roller 20, a cooling water system 30 and a printing machine 40. The oven 10 heats a plain cloth PC for softening. The cold pressing roller 20 is provided with a predetermined pattern 21 and is connected to the cooling water system 30 which provides the cold pressing roller 20 with the cold water for cooling. The cold pressing roller 20 cools the plain cloth PC and forms an embossed pattern on the plain cloth PC, such that an embossed layer EL with the embossed pattern is formed on the plain cloth PC. Wherein, the embossed pattern is an inverse of the predetermined pattern 21, and a depth of the cooled embossed layer EL is the same as a depth of the predetermined pattern 21. The printing machine 40 may print a colored layer CL and crop mark CM.

In one embodiment, as illustrated by FIG. 2, the printing machine 40 prints a colored layer CL on the embossed layer EL and there is no crop mark CM on the plain cloth PC. The embossed layer EL may partially cover the plain cloth 10.

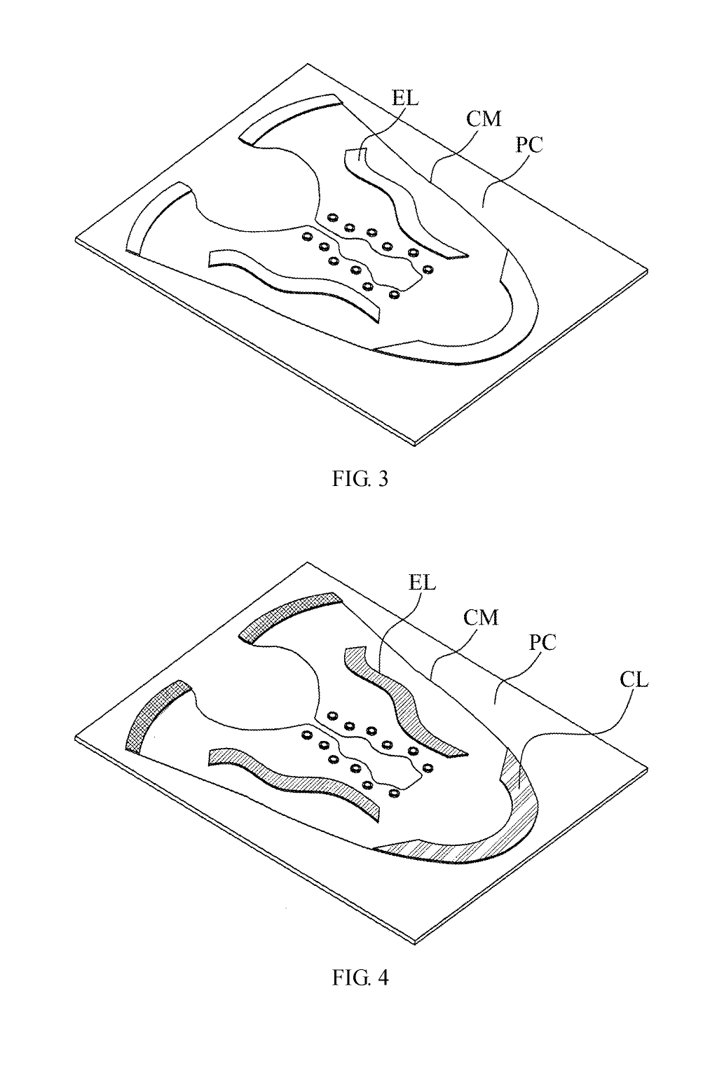

In the another embodiment, as illustrated by FIG. 3, the plain cloth PC remains as a white cloth and any further water pollution due to a dying process is avoided. The printing machine 40 prints a crop mark CM on the plain cloth PC. After forming the embossed layer EL, the processed cloth can be cropped along the crop mark CM to form the vamp with the embossed pattern.

In the another embodiment, as illustrated by FIG. 4, the printing machine 40 prints a colored layer CL and crop mark CM on the plain cloth PC. The embossed layer EL may partially cover the plain cloth 10. The positions of the colored layer CL, crop mark CM and the embossed layer EL are different from each other. The colored layer CL and the embossed layer EL are in the range of a region defined by the crop mark CM. The embossed layer EL is at the left side or the right side of the plain cloth PC. The colored layer CL is in the front side of the plain cloth PC. Similarly, the processed cloth can be cropped along the crop mark CM to form the vamp with the embossed pattern.

No matter what the foregoing structural diagram is, because of the cold pressing roller 20, the embossed layer EL can maintain its appearance and be acted as a logo or a reinforcement structure. Besides, the embossed layer EL may extend slightly beyond the preset area and blend with the area of the plain cloth PC not intended to be embossed. Indeed, the description that the embossed layer EL covers the plain cloth PC is not intended to limit the scope of the present invention.

Wherein, the plain cloth PC is a sandwiched fabric, and the sandwiched fabric is provided with a hot-melt adhesive yarn with dual melting points. In detail, when the knitting machine knits the hot-melt adhesive yarn together with the at least one other different kind of yarn (such as cotton, polyester, polyamide or rayon, or a combination thereof) to form the plain cloth PC, the area to be embossed into the embossed layer EL (for the purpose of applying the predetermined design pattern or structural reinforcement) is knitted with a higher-density of the hot-melt adhesive yarn than the other area on the plain cloth PC. This is done in order to facilitate the formation of the embossed layer EL, and is done in a controlled manner, for instance by setting a suitable composition configuration on the knitting machine. In another embodiment, the hot-melt adhesive yarn may be a fiber yarn that has dual melting points. For example, the inner core and outer cladding layer of the fiber yarn may differ in their melting points. The outer cladding layer may have a lower melting point that facilitates the weaving process and increases the color fastness of the yarn fiber if dyed. The inner core may have a higher melting point and a higher stiffness and so provide for a more sturdy structure of the vamp. The desired characteristics of the hot-melt adhesive yarn are developed as follows. Yarn of the same material but with different melting points for the inner and outer layers can be produced in the process of drawing the yarn by controlling the degree of crystallization of the fibers or by wrapping the drawn yarn with the same yarn material. Due to the inner and outer layers of the yarn originating from the same material, their physical properties are similar and this simplifies the procedure for controlling the parameters for the knitting process. Also, when the yarns are made from the same material, recovery of leftover selvage is easier, and so a greater proportion of the yarn can be recycled, thus reducing the cost, energy use, and environmental impact of the manufacture of the vamp.

The predetermined stamp may include a predetermined design pattern (such as a logo or other mark) to be formed on the vamp, or may include a reinforcement structure, which is a pattern that acts to reinforce the structure of the vamp and may be applied in areas where extra reinforcement structure is desirable, such as at the toe, edges of eyelets, or shoe heel. Shoes provided with such reinforcement structure of the vamp may have better structural support or a greater resistance to wear and tear. To summarize, the embossed layer EL is formed on the vamp, to form the predetermined design pattern, the reinforcement structure, or a combination thereof.

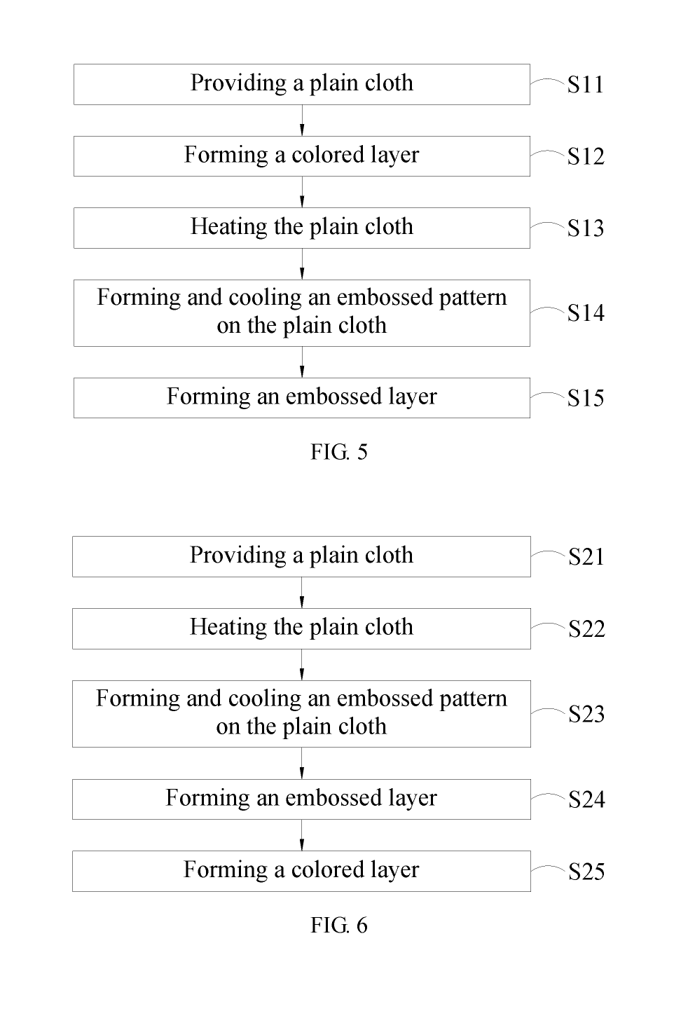

Please refer to FIG. 5, depicts a flow chart of the first embodiment according to the manufacturing method of a vamp with an embossed pattern. As illustrated by FIG. 5 and in collocation with FIG. 1 to FIG. 4, the manufacturing method of the vamp with the embossed pattern comprising: (1) S11 step: providing a plain cloth PC, and there is a crop mark CM on the plain cloth PC; wherein, the plain cloth PC is a sandwiched fabric, and the sandwiched fabric is provided with a hot-melt adhesive yarn with dual melting points. (2) S12 step: forming a colored layer CL on the plain cloth PC by printing of the printing machine 40, and the colored layer CL is in a range of an region defined by the crop mark CM. (3) S13 step: heating the plain cloth PC by an oven 10 to soften the plain cloth PC. (3) S14 step: forming and cooling an embossed pattern on the plain cloth PC by the cold pressing roller 20 at the same time. In detail, because the cold pressing roller 20 has the predetermined pattern 21 and is connected to the cooling water system 30 which provides the cold pressing roller 20 with the cold water, the cold pressing roller 20 is able to form and cool the embossed pattern at the same time. Because of the hot-melt adhesive yarn with dual melting points, the outer layer of the plain cloth PC is softened after the heating process and the cold pressing roller 20 presses the plain cloth PC, and then forms and cools embossed pattern on the plain cloth PC. (4) S15 step: forming an embossed layer EL with the embossed pattern on the plain cloth PC, and the processed cloth can be cropped along the crop mark CM to form the vamp with the embossed pattern. Wherein, the cooled embossed pattern is an inverse of the predetermined pattern 21 and the depth of the cooled embossed layer EL is the same as a depth of the predetermined pattern 21. Because of the cold pressing roller 20, the embossed layer can maintain its appearance and be acted as a logo or a reinforcement structure.

Please refer to FIG. 6, depicts a flow chart of the second embodiment according to the manufacturing method of a vamp with an embossed pattern. As illustrated by FIG. 5 and in collocation with FIG. 1 to FIG. 4, the manufacturing method of the vamp with the embossed pattern comprising: (1) S21 step: providing a plain cloth PC, and there is a crop mark CM on the plain cloth PC; wherein, the plain cloth PC is a sandwiched fabric, and the sandwiched fabric is provided with a hot-melt adhesive yarn with dual melting points. (2) S22 step: heating the plain cloth PC by an oven 10 to soften the plain cloth PC. (3) S23 step: forming and cooling an embossed pattern on the plain cloth PC by a cold pressing roller 20 at the same time. In detail, because the cold pressing roller 20 has the predetermined pattern 21 and is connected to the cooling water system 30 which provides the cold pressing roller 20 with the cold water, the cold pressing roller 20 forms and cools the embossed pattern at the same time. Because of the hot-melt adhesive yarn with dual melting points, the outer layer of the plain cloth PC is softened after the heating process and the cold pressing roller 20 presses the plain cloth PC, and then forms and cools embossed pattern on the plain cloth PC. (4) S24 step: forming an embossed layer EL with the embossed pattern on the plain cloth PC. (5) S25 step: forming a colored layer CL on the plain cloth PC by printing of the printing machine 40, and the colored layer CL is in a range of a region defined by the crop mark CM. The processed cloth can be cropped along the crop mark CM to form the vamp with the embossed pattern. Wherein, the cooled embossed pattern EL is an inverse of the predetermined pattern 21 and the depth of the cooled embossed layer EL is the same as the depth of the predetermined pattern 21. Because of the cold pressing roller 20, the embossed layer EL can maintain its appearance and be acted as a logo or a reinforcement structure.

It is worthy to mention that the printing method of the printing machine 40 comprises the ink jet printing, the cold and hot peel transfers, the fabric dyeing, the screen printing and the digital printing, and the foregoing description is merely as example and is not intended to limit the scope of the present invention. Preferably, the printing method of the printing machine 40 is the digital printing. The digital printing is performed to only stain the area of the vamp that includes the embossed pattern. The leftover cloth to be cut is not stained, thereby reducing costs related to the time taken to stain and the amount of yarn material to stain. Moreover, the unstained cut leftovers may be recovered, recycled and reused, thus making further savings in the cost of the yarn material used and so reducing the environmental impact of the manufacture of the vamp. Different areas of the colored layer CL may be stained with different colors.

No matter what the foregoing manufacturing method of the vamp with the embossed pattern is, the heating temperature and the cooling temperature is vital to the process of heating the plain cloth PC and cooling the plain cloth PC. If there is no cooling process and the mold and the thermal compression machine would do the thermal compression molding process on the plain cloth PC, the heated plain cloth PC just is placed in the air, the cooling velocity is too slow and the hot-melt adhesive yarn in the outer cladding layer of the sandwiched fabric would spring back a little. Hence, the depth of the cooled embossed layer EL is different from the depth of the molding.

In the foregoing manufacturing method of the vamp with the embossed pattern of the present invention, there are heating process and the cooling process. The plain cloth PC is heated by the oven and the heating temperature for heating the plain cloth PC is in the range of 150° C. to 190° C. The cold pressing roller 20 with a predetermined pattern 21 perform the cooling and pressing process on the plain cloth PC, and the cooling temperature for cooling the plain cloth PC is in the range of 15° C. to 30° C. Afterwards, the embossed layer EL with embossed pattern is formed on the plain cloth PC. Because of cooling process, the depth of the cooled embossed layer EL is the same as the depth of the predetermined pattern 21, and the embossed layer EL would maintain its appearance without springing back. It is needed to mention that the heating temperature and the cooling would change according to the material of the plain cloth PC, and the foregoing description is merely as example and is not intended to limit the scope of the present invention.

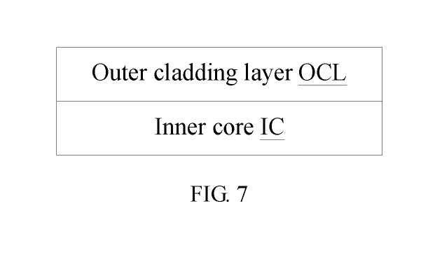

Please refer to FIG. 7, which depicts a structural diagram of the hot-melt yarn according to the manufacturing method of a vamp with an embossed pattern. As illustrated by FIG. 7, the plain cloth PC is a sandwiched fabric, and the hot-melt yarn of sandwiched fabric is provided with inner core IC and outer cladding layer OCL. The outer cladding layer OCL is made of the hot-melt adhesive yarn with lower melting point such as 150° C. to 190° C., and the inner core IC is made of the polyester with higher melting point such as 190° C. to 250° C. In collocation with FIG. 1 to FIG. 6, the oven 10 heats the sandwich fabric at 150° C. to 190° C. Afterwards, the outer cladding layer OCL would be softened due to heating and the inner core IC would not be softened due to its higher melting point. The cold pressing roller 20 presses the outer cladding layer OCL at room temperature such as 25° C., and at the same time the cold water system provides the cold water at 15° C. to 25° C. for cooling. That is, the forming and cooling process is performed by the cold pressing roller 20 at the same time. Hence, the embossed layer EL with embossed pattern is formed on the sandwiched fabric.

In accordance with the above description, the manufacturing method of the vamp with the embossed pattern and the manufacturing system thereof utilizes the heating process, the cooling and forming process to maintain the appearance of the embossed layer EL. The depth of the cooled embossed layer EL is the same as the depth of the predetermined pattern 21. That is, the embossed layer EL would not spring back. In brief, the manufacturing method of the vamp with the embossed pattern and the manufacturing system thereof has many advantages and utilizes the simple steps to maintain the appearance of the embossed layer EL, thereby reducing the costs and the manufacturing time of the embossed layer EL.

The above description is for the purpose of illustration only and shall not be interpreted in any way to limit the scope, configuration or applicability of the present invention. A person skilled in the art may carry out many changes and modifications in the described embodiments without departing from the spirit and the scope of the present invention, which is intended to be limited only by the appended claims.

What is claimed is:

1. A manufacturing method of a vamp with an embossed pattern, comprising:
providing a plain cloth;
heating the plain cloth by an oven to soften the plain cloth;
forming and cooling an embossed pattern on the plain cloth by a cold pressing roller at the same time, and the cold pressing roller provided with a predetermined pattern; and
forming an embossed layer with the embossed pattern on the plain cloth;
wherein, the cooled embossed pattern being an inverse of the predetermined pattern and a depth of the cooled embossed layer being the same as a depth of the predetermined pattern.

2. The manufacturing method of a vamp with an embossed pattern of claim 1, after providing the plain cloth, forming a colored layer on the plain cloth by printing.

3. The manufacturing method of the vamp with the embossed pattern of claim 2, wherein, the plain cloth is provided with a crop mark, and the colored layer is in a range of an region defined by the crop mark

4. The manufacturing method of the vamp with the embossed pattern of claim 1, after forming the embossed layer, forming a colored layer on the embossed layer by printing.

5. The manufacturing method of the vamp with the embossed pattern of claim 1, wherein the plain cloth is a sandwiched fabric, and the sandwiched fabric is provided with a hot-melt adhesive yarn with dual melting points.

6. The manufacturing method of the vamp with the embossed pattern of claim 1, a heating temperature for heating the plain cloth is in the range of 150° C. to 190° C.

7. The manufacturing method of the vamp with the embossed pattern of claim 1, a cooling temperature for cooling the plain cloth is in the range of 15° C. to 30° C.

8. The manufacturing method of the vamp with the embossed pattern of claim 1, the cold pressing roller is connected to a cooling water system.

9. A manufacturing system of a vamp with an embossed pattern, comprising:
an oven, heating a plain cloth; and
a cold pressing roller, provided with a predetermined pattern thereon, the cold pressing roller forming and cooling an embossed pattern on the plain cloth at the same time, such that an embossed layer with the embossed pattern is formed on the plain cloth;
wherein, the embossed pattern being an inverse of the predetermined pattern, and a depth of the cooled embossed layer being the same as a depth of the predetermined pattern.

10. The manufacturing system of claim 9, further comprising a printing machine, the printing machine prints a colored layer on the plain cloth.

11. The manufacturing system of claim 10, wherein, the printing machine prints a crop mark on the plain cloth and the colored layer is in the range of a region defined by the crop mark.

12. The manufacturing system of claim 9, further comprising a printing machine, the printing machine prints a colored layer on the embossed layer.

13. The manufacturing system of claim 9, wherein the plain cloth is a sandwiched fabric, and the sandwiched fabric is provided with a hot-melt adhesive yarn with dual melting points.

14. The manufacturing system of claim 9, the cold pressing roller is connected to a cooling water system.
